(19) United States
(12) Patent Application Publication
(10) Pub. No.: US 2007/0160771 A1
(43) Pub. Date: Jul. 12, 2007

(54) Electrically-conductive plastic hangers

(75) Inventor: Kissak T. Sarajian, Montrose, CA (US)

Correspondence Address: JANSSON SHUPE & MUNGER LTD., 245 MAIN STREET, RACINE, WI, 53403, US

(73) Assignee: Engineered Products and Services, Inc.

(21) Appl. No.: 11/329,350

(22) Filed: Jan. 10, 2006

(51) Int. Cl. B05C 13/00; B05D 1/04

(52) U.S. Cl. 427/458; 118/500

(57) ABSTRACT

Electrically-conductive plastic hangers for supporting a workpiece during an electrostatic coating, plating, treating or other processing operation are described herein. In embodiments, the hangers have a one-piece hanger body made of an electrically-conductive plastic material, a connector portion configured to hang the hanger from a rack or other support and a further connector portion configured to hang a workpiece directly from the hanger.

### FIELD

The field is supports and, more particularly, electrically-conductive hangers for supporting one or more workpieces in coating and other processing operations.

### BACKGROUND

It is common practice in industry to coat, plate, treat and otherwise process workpiece surfaces in order to impart desired characteristics to such surfaces. To facilitate performance of these operations, the workpiece should be supported such that the workpiece surfaces of interest are exposed to the coating or other material to be applied to the workpiece. For electrically-conductive workpieces, these operations may be further facilitated by imparting an electrostatic charge to each workpiece so that oppositely-charged coatings and other materials are attracted onto the workpiece. Typically this is accomplished by grounding the workpiece although imparting any electrical state suitable for attracting coatings and other materials to the workpiece is acceptable. The support selected for use in such operations should facilitate imparting of the desired electrical state or charge to the workpiece.

Powder coating and electro-deposition coating (“E-coating”) processes are representative processes in which it is desirable to both support and ground the workpiece in order to optimally perform the process. In a typical powder coating process, electrostatically charged powdered paint (usually a form of finely ground plastic particles) is deposited onto the workpiece by, for example, spray application in a spray booth. Each workpiece may be delivered to the spray booth by a coating line conveyor. In other operations, the workpiece may simply be manually suspended from a hook, rack or like support within the spray booth.

Each workpiece is typically suspended from the conveyor or from a hook or rack in the coating booth by means of a hanger so that the workpiece surfaces are exposed to the coating material and so that the coating material may be deposited on such surfaces. The hanger is typically made of an electrically-conductive metal material so that the workpiece can be electrostatically charged, typically by grounding.

Hangers are available in many shapes and forms, including small individual wire hooks, supports, or large welded racks with multiple hanging points. Conventional individual hooks typically have a generally C-shaped appearance. Conventional large welded racks may comprise a 2 foot by 3 foot “frame” with end members and cross bars suspended across it. Each cross bar will contain 20 to 100 small hooks or posts welded to it. These racks are time consuming and costly to manufacture because many separate welds are required.

Materials used in hanger manufacture include standard or stainless steel. High-temperature-resistant metals are desirable because such metals can withstand the high temperatures used to remove or “burn off” excess coating during cleaning of the hangers. Such temperatures can exceed 1000 degrees Fahrenheit (° F.).

In the coating booth, coating particles may be electrostatically charged such that the particles have a charge which is opposite of the charge on the workpiece. The charge may be imparted with either a corona gun or Tribo gun, each of which ionize the coating particles. The devices work quite differently, but the end result is the same in that a cloud of ionized coating is produced about the workpiece surfaces. The electrostatically charged particles are attracted to the oppositely charged workpiece by natural static electricity. The coating particles attach to any oppositely charged article, including the workpiece and the grounding hanger or hook.

The electrostatic charge attraction carries the coating until the workpiece and supporting hanger reach the curing oven. In the curing oven, the coating is cured at an average temperature of about 400° F. or lower for approximately 30 minutes. Times and temperatures vary depending type of powder coating material utilized. Typical powder coating paints are thermoplastic materials and consist of powdered forms of polyester, urethane, acrylic and other materials.

During curing, the heated coating partially liquefies and then cures to form an extremely durable and strong film on the workpiece surfaces. The cured coating is almost impossible to remove once cured and will remain intact at temperatures of up to about 950° F. if the workpiece was properly cleaned before the coating operation. The coating material cures not just on the workpiece but on the hanger which supports the workpiece during the curing process.

After cooling, the coated workpiece is removed from the hanger and is processed further if desired. The hanger is then recycled for use in subsequent coating cycles. Because conventional metal hooks, hangers and racks are relatively costly, it is advantageous to reuse these types of supports as many times as possible to minimize cost to the operator.

In E-coating processes, the workpiece to be coated, treated or processed is initially mounted on a hanger, such as a hook, rack or other support. The workpiece is electrostatically charged (e.g. grounded) through contact with the hanger. The workpiece is then immersed or dipped in a liquid-containing submersion tank or vessel. The submersion tank contains ionized coating particles having a charge which is opposite that of the workpiece much like the powder coating process described above. The coating is deposited onto the workpiece surfaces by charge attraction. The end result of an E-coating process is similar to that of powder coating, but typically creates a thinner, more consistent coating provided that the workpiece surfaces can be suitably accessed by the coating or other material.

E-Coating processes may require that the workpiece surfaces be pre-treated before application of the coating. One or more separate submersion tanks may be provided for this purpose, each including mild acids to etch and clean the workpieces prior to coating. Proper treatment of the workpiece surfaces, either by treatment before application of the coating, or with the coating itself requires that the surfaces be freely accessible.

As with the powder coating processes described above, the hanger is typically reused after the coated workpiece is removed from the hanger.

An undesired side effect of reusing the hangers in subsequent powder coating or E-coating cycles is that the coating material builds up on the hanger. This is a problem for the operator because the coating build up interferes with charging of the workpiece.

As noted, the coating material is attracted to anything which has an opposite electrostatic charge, including the hanger. The coating itself is non-conductive. After one or two coating cycles, the contact point between the hanger and the workpiece supported by the hanger receives a thin insulating layer of the coating material. This insulating layer of coating material interferes with electrostatic charging of the workpiece such that the coating material is not properly attracted to the workpiece surfaces. As a result, the coated workpiece may be defective or excessive amounts of coating material may be required to coat the workpiece thereby imposing undesired costs on the operator.

One solution to this problem has been to clean and remove the coating build up from the hangers. The typical (i.e., least expensive) cleaning method is to burn the excess coating off the hanger in a burn-off oven. As noted previously, the burn-off oven generates temperatures of 1000° F. This heat turns the coating to ash which crumbles off of the hanger. This cleaning process is not optimal, however, because the ash may contain potentially toxic materials thereby creating disposal problems and further because the burn-off process generates unwanted fumes and off-gases.

Another solution to the coating build up problem has been to chemically strip the coating from the hanger. Chemical stripping typically involves the use of highly volatile acids which dissolve the coating. As can be appreciated, use of chemical stripping agents can create waste disposal issues.

Others have used vibratory cleaning as a method of removing coating build up from the hangers. Vibratory cleaning involves violent shaking of the hangers such that the coating starts to chip or break off of the hanger. Vibratory cleaning can damage the hangers. And, vibratory cleaning is not an optimal cleaning technique because it does not fully remove coating from the hangers thereby leaving coating fragments attached to the hangers. These fragments are known to sluff off of the hangers during subsequent coating cycles potentially contaminating the workpieces and the operator's facility as the hangers are re-used in subsequent coating cycles.

Obviously, each of these hanger-cleaning processes involve added labor and material costs to the coating process. While these costs can be avoided by simply discarding the hangers after one use, it is apparent that discarding of the metal hangers after a single use imposes still other costs on the operator.

One solution to the problem of coating build up on the workpiece-supporting hanger is described in U.S. Pat. No. 6,579,369 (DeWent). The proposed solution is to attach an electrically-conductive silicone intermediate to a hanger. The intermediate supports the workpiece and can be removed from the hanger and replaced thereby permitting re-use of the hanger. The patent also describes hangers to which a flexible electrically-conductive silicone coating is applied. Apparently, coating materials do not adhere well to the silicone and can be easily removed after conclusion of the coating cycle.

While these may be worthy solutions, they do impose added costs in that labor costs are incurred in order to attach and remove the intermediates from the hangers. And, application of a separate conductive coating to a metal hanger involves additional steps and materials which increases the costs of these types of hangers to the operator. Over time, it is expected that coating will build up on these intermediates and the intermediates will need to be discarded.

While the aforementioned coating-related issues are described in the context of powder and E-coating processes, many other industries require the use of workpiece hanger systems that facilitate imparting an electrical state to the workpiece as well as access to the workpiece surfaces. These industrial processes include, for example, electro-plating, anodizing, and application of autoferretic coatings.

It would be a significant advance in the art to provide an improved hanger which would facilitate application of coatings and other materials to a workpiece, which would avoid problems associated with coating build up on the hanger in subsequent coating cycles and which would be inexpensive and easy to use.

### SUMMARY

The present inventor has recognized that electrically-conductive plastic hangers may be implemented for supporting a workpiece during electrostatic coating, treating or other workpiece-processing operations. Hangers as described herein can be manufactured in a wide range of shapes, sizes, configurations and materials to meet the needs of the operator.

In embodiments, the hangers are provided with a one-piece hanger body made of an electrically-conductive plastic material. The body includes a connector portion configured to hang the body from a rack or other support and a connector portion capable of hanging a workpiece from the hanger body. It is preferred that the body is made entirely of the plastic material. It is envisioned, however, that other conductive and non-conductive parts, such as an appendage for gripping the hanger, may be associated with the electrically-conductive hanger body.

Electrically-conductive plastic materials suitable for use in making the hangers comprise one plastic material or plural plastic materials in combination with one conductive material or plural conductive materials. The materials selected for use in making the hangers should as a whole provide sufficient conductivity to permit the desired electrostatic state or charge to be imparted to the workpiece. Typically, the workpiece will be grounded. However, it is to be understood that any desired state may be imparted to the workpiece through the hanger.

In certain other embodiments, the materials are selected so that the hanger is capable of withstanding temperatures of up to about 450° F. Preferably, the materials can be exposed to this temperature range for about 30 minutes without deformation. Hangers may, of course, be used in applications in which elevated temperatures are not involved and such hangers may be made of any suitable material or materials.

In certain preferred embodiments, the connector portions comprise a first connector portion which includes one or more hooks used to support the hanger from a rack or other support or conveyance. It is further preferred that a second connector portion comprises one or more hooks used to suspend a workpiece from the hanger. In other embodiments, the connector portions may take on configurations other than hooks. Examples are spiral or helical configuration connectors, snap hook mechanisms or locking hook mechanisms.

Hangers may be made according to many different manufacturing processes. Preferred representative processes include injection molding, blow molding and compression molding. An advantage of molding processes is that the hangers can be mass produced at cost which is a fraction of the cost of conventional metal hangers thereby enabling the operator to discard the hangers at the end of the coating cycle.

Methods of coating a workpiece using an electrically-conductive plastic hanger are included.

### BRIEF DESCRIPTION OF THE DRAWINGS

The invention may be understood by reference to the following description taken in conjunction with the accompanying drawings, in which like reference numerals identify like elements throughout the different views. The drawings are not necessarily to scale, emphasis instead being placed upon illustrating the principles of the invention.

FIG. 1 is a perspective view of an exemplary electrically-conductive plastic hanger. The hanger is supported on an exemplary hook-type support. An exemplary workpiece is supported by the hanger.

FIG. 2 is a perspective view of the hanger of FIG. 1 but without the exemplary hook and workpiece.

FIG. 3 is an enlarged schematic section view taken along section line 3-3 of FIG. 2.

FIG. 4 shows a unit of plural hangers of the type in FIGS. 1-3.

FIGS. 5A-5E are enlarged schematic section views taken along a section line, such as section 3-3 of FIG. 1, provided to show representative alternative hanger sectional profiles.

FIG. 6 is a perspective view of a further exemplary electrically-conductive plastic hanger.

FIG. 7 is a perspective view of another exemplary electrically-conductive plastic hanger.

FIG. 8 is a perspective view of yet another exemplary electrically-conductive plastic hanger.

FIG. 9 is a perspective view of a an additional exemplary electrically-conductive plastic hanger.

FIG. 10 is a perspective view of an exemplary electrically-conductive plastic hanger in the form of a rack having plural connector portions for supporting a workpiece or workpieces.

### DETAILED DESCRIPTION OF PREFERRED EMBODIMENTS

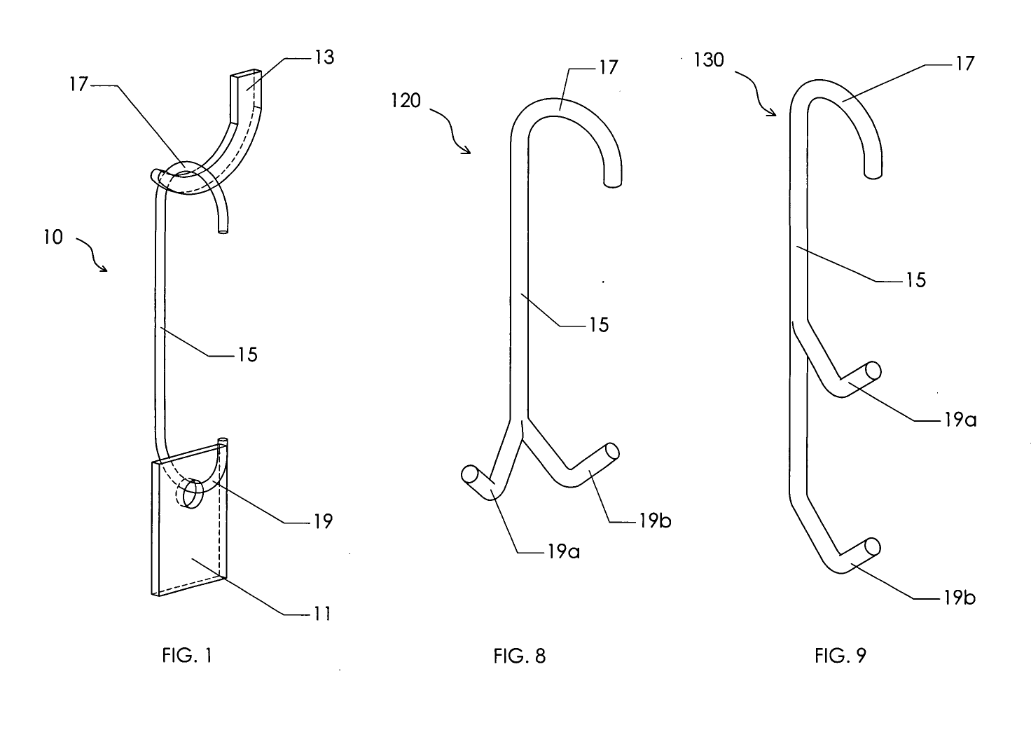

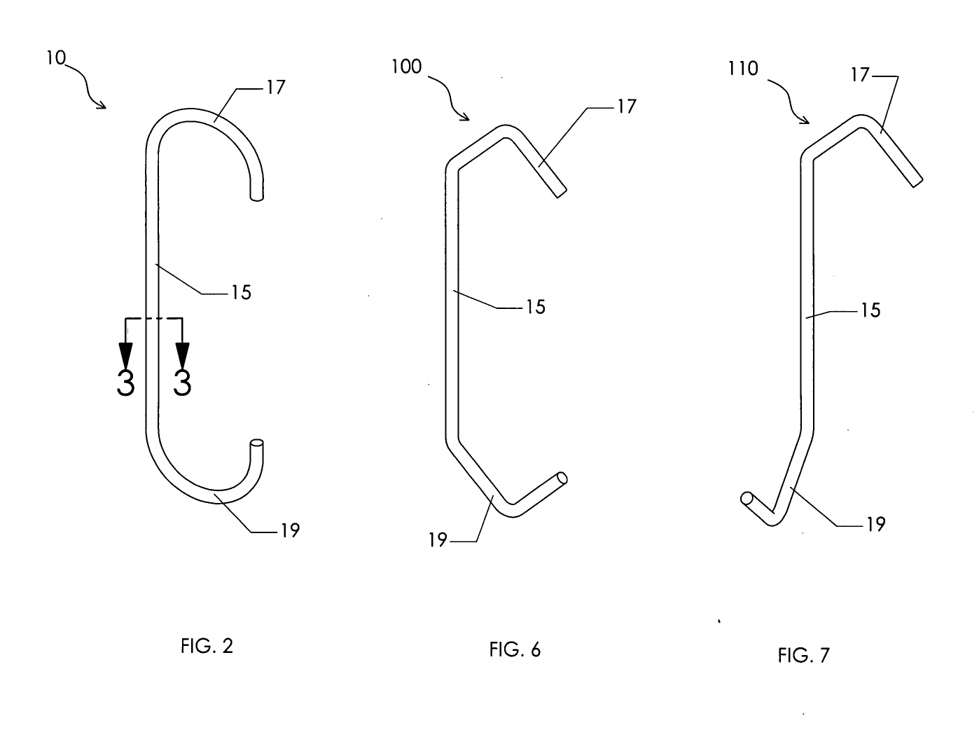

Referring first to FIGS. 1-3, those figures show a preferred embodiment of an electrically-conductive plastic hanger 10. Hanger 10 is of the type used to support a workpiece 11 from the hook 13 of a rack, support or conveyance (not shown) during electrostatic coating, treating or processing of the workpiece 11. Typically, hook 13 and its rack, support or conveyance are grounded or otherwise electrostatically charged. Hanger 10 serves as an electrical conductor permitting the operator to impart a desired electrostatic state or charge to workpiece 11 so that oppositely charged coatings and other materials will be attracted onto workpiece 11. Most typically, hanger 10 and workpiece 11 are placed in a grounded electrostatic state. However, it is to be understood that hangers as described herein may be utilized to impart any desired charge or state to workpiece 11 so that the coating or other material is attracted to workpiece 11.

The supported electrostatically charged workpiece 11 may be coated, treated or processed. Typically, such treatment or processing is performed in a spray booth, submersible tank, or other apparatus adapted to apply coating or other desired material to workpiece 11. Such operations may include any of those known to persons of skill in the art and include, without limitation, powder coating, E-coating, electro-plating, anodizing, application of autoferretic coatings as well as cleaning, etching and other forms of surface treatment.

“Plastic” as used to characterize hanger 10 and the other hanger embodiments described herein is intended to be a broad term which means or refers to any of the numerous organic, synthetic or processed polymeric materials that can be molded, cast, extruded, drawn or otherwise made into objects such as hangers.

An “electrically-conductive plastic material” means or refers to a material which comprises a plastic component and a conductive component. The plastic component may comprise one plastic material or plural plastic materials. The conductive component may comprise one conductive material or plural conductive materials. The plastic and conductive materials may be associated by any suitable means including, for example, by embedding conductive material in the plastic. Embedding, or to embed, means or refers to making conductive material an integral part of the plastic, for example embedding conductive particles in a plastic matrix.

As used herein, “hanger” means or refers to any hook, support, rack, stand, framework or other contrivance from which a workpiece is hung, held or otherwise supported. A hanger may simultaneously support plural workpieces.

“Electrostatic” means or refers to a process involving the use of electrical charge to produce attraction of the coating or other material to workpiece 11.

Referring again to FIGS. 1-3, hanger 10 shown therein has a one-piece, unitary hanger body 15 which includes first and second connector portions 17, 19. As illustrated in FIG. 1, first connector portion 17 is preferably configured to hang body 15 from hook 13 or other support and second connector portion 19 is preferably configured to directly support workpiece 11.

In preferred embodiment 10, body 15 is a generally C-shaped member with first and second connector portions 17, 19 respectively forming upper and lower hooks. As shown in FIG. 3, body 15 preferably has a rounded shape in section. In the preferred embodiment 10, hanger body 15, including connector portions 17, 19, lies generally in a plane.

Body 15 is made of electrically-conductive plastic material. Most preferably, body 15 is made entirely of such plastic material. Other conductive or non-conductive parts, such as a gripping appendage or an auxiliary hook (not shown), may be associated with the electrically-conductive hanger body 15.

As represented schematically in FIG. 3, a preferred electrically-conductive plastic may comprise plastic component 21 and conductive component 23 embedded therein to impart the electrical conductivity. Plastic component 21 preferably comprises a thermoplastic material. Representative thermoplastic materials include polyether ether ketones, polyphenylene sulfides, polyethylenes, liquid crystal polymers, and nylon 6-6. Any plastic material will suffice provided that the material can support hanger 10 from a support such as hook 13 and can support a workpiece 11.

Conductive component 23 is selected so as to provide the desired conductivity. Conductive component 23 should be distributed throughout plastic component 21 such that conductive component 23 is dispersed or distributed in a generally uniform, or homogenous, manner within body 15. The “homogenous” dispersal or distribution of conductive material 23 means only that conductive material 23 is dispersed or distributed sufficiently within body 15 such that hanger 10 can conduct the desired electrical charge. As shown in FIG. 3, in any given portion of hanger 10, conductive material 23 can and likely will be distributed in an irregular manner within plastic material 21.

Representative materials for use as conductive component 23 include metallic powders, carbon black, carbon fibers, carbon mats, and metallized glass fibers and spheres. Copper, aluminum, gold, and other conductive materials may be utilized. Mixtures of the conductive materials may be utilized. Conductive material 23 may be in any form permitting generally uniform or homogenous distribution throughout plastic material 21 comprising body 15. Examples are powders, flakes, granules and fibers. As shown in FIG. 3, conductive material 23 can comprise conductive materials of varying sizes including, for example, large and relatively smaller materials.

Conductive component 23 may be associated with plastic component 21 in any suitable manner. For example, conductive component 23 may be in flake or powder form and may be admixed with a granular-form plastic component 21 at any time before formation of body 15. Upon formation of body 15, conductive material 23 would be distributed or embedded within plastic component 21.

Representative thermoplastic polyether ether ketones are sold under the trademark PEEK by Victrex USA, Inc. of Greenville, South Carolina and representative thermoplastic polyphenylene sulfides are marketed under the tradename Techtron® PPS by Boedeker Plastics, Inc. of Shiner, Texas. Each of these representative plastic component 21 materials can be made electrically conductive by adding a 30% carbon fiber component 23 to plastic component 21.

The only requirement of the plastic and conductive components 21, 23 is that the finished hanger 10 have sufficient conductivity to adequately ground or otherwise impart an electrostatic charge to workpiece 11. Therefore, conductive component 23 must be present in sufficient amount to serve as a conductor. It is expected that the specific amount of conductive component 23 utilized will vary based on factors such as the plastic material 21 selected and the requirements of the operator. It is possible to adjust the relative amount of conductive material 23 in hanger body 15 to control the amount of conductivity. Preferably, the material or materials selected for components 21, 23 are such that hanger 10 has a very low resistance thereby facilitating charging or grounding of the workpiece supported by hanger 10. It is preferred that hanger 10 has a resistance of less than about 1 megaohm with a resistance of less than about 0.1 megaohm being more preferred.

For hanger 10 embodiments intended for use in coating operations where high-temperature curing is required, the plastic component 21 should preferably be selected such that hanger 10 is capable of withstanding temperatures up to about 450° F. Preferably, the plastic component 21 materials can be exposed to this temperature range for about 30 minutes without deformation. Without deformation means that the hanger 10 substantially retains its configuration. Hangers such as hanger 10 are intended to be utilized in many different applications including those in which the hanger 10 and workpiece 11 are not exposed to elevated temperatures. Hangers for use in such applications may be made of any suitable plastic component 21 material.

Hanger 10 is most preferably the product of conventional plastic forming processes known to persons of skill in the art. Hanger 10 may be formed, for example, by injection molding, blow molding and compression molding. The product of such a forming process is a body 15 and connector portions 17, 19 which are formed integrally as a one-piece, unitary part.

Injection molding is a particularly preferred process by which to form hanger 10 because of the ease of preparing the components 21, 23 and forming the hanger. Injection molding provides the capability of making one or more hangers in a single mold shot thereby reducing costs. Preferably, plastic and conductive components 21, 23 are in dry flowable form and are admixed before heating. The ratio of components 21, 23 is not critical provided that the desired conductivity is provided. Plastic component 21 is heated until molten and then the molten plastic 21 and conductive component 23 are shot into the mold followed by cooling.

The cavity of the tool or mold may be configured to produce separate hangers (e.g., hanger 10). And, the tool or mold may be configured to simultaneously produce a group or unit 27 of formed together hangers, one example of which is shown in FIG. 4. The unit 27 shown in FIG. 4 consists of 10 hangers (each identified by reference number 10 for convenience) formed together and joined by connectors in the form of mold runners 25. Runners 25 are not required. Any type of connector part may be used in place of runners 25 if connection between hangers 10 of unit 27 is desired. The tool or mold may be designed such that hangers 10 can be separated or broken easily from each runner 25 by hand or with a cutting tool.

There is no limit with respect to the configuration and arrangement of hangers 10 or runners 25 or the number of hangers 10 or runners 25 which can be produced in a single molding operation. The objective is to provide the hanger manufacturer with flexibility to meet the operator's requirements thereby permitting the hanger manufacturer to efficiently mass produce hangers 10 and to reduce the cost of each hanger 10.

While preferred hanger embodiment 10 has been described in detail, it is to be understood that other hanger configurations may be utilized and that the hanger can be provided in virtually any configuration necessary to meet the needs of the operator. For example, body 15 may have sections other than the rounded section shown in FIGS. 1-4, and particularly in FIG. 3. As shown in FIGS. 5A-5E, the cross-sectional configuration may be in the shape of a diamond (FIG. 5A), a rectangle (FIG. 5B), an I-beam (FIG. 5C), a star (FIG. 5D), and virtually any other shape as represented by FIG. 5E. Combinations of such sectional configurations may be utilized.

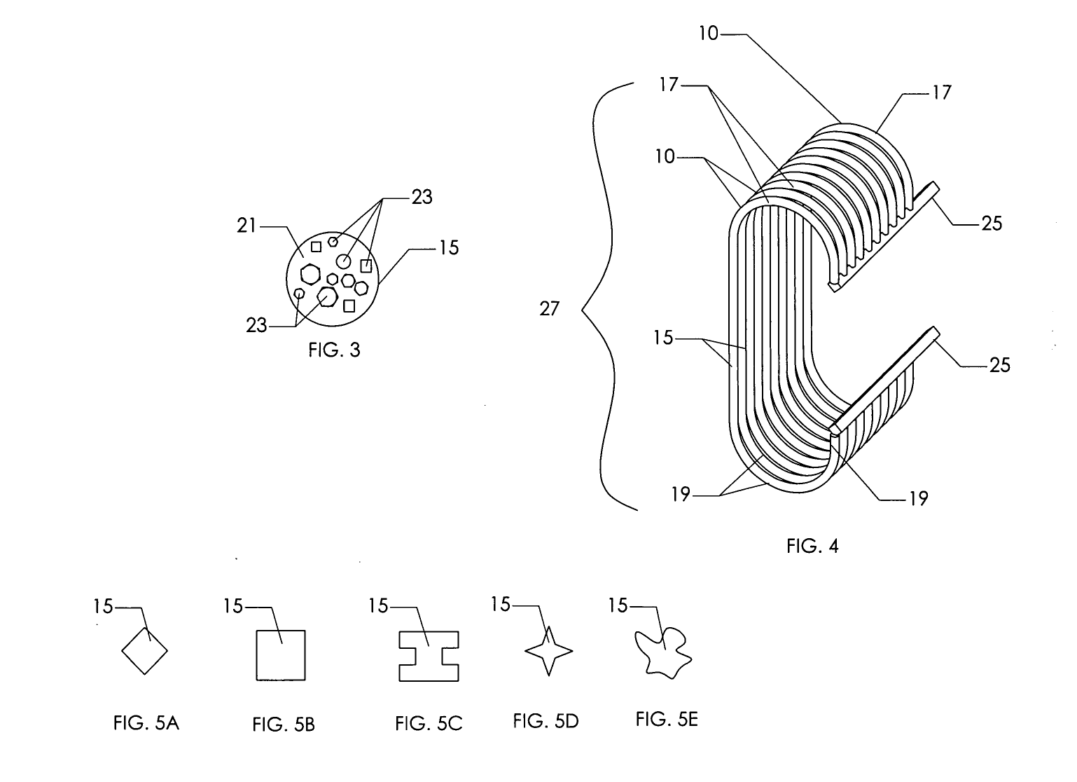

By way of further example, body 15 and connector portions 17, 19 may have configurations other than the generally planar C-shaped configuration shown in FIGS. 1-4. Hangers as described herein may be custom manufactured to any configuration required by the customer. As shown in FIG. 6, exemplary hanger 100 may have a generally C-shaped profile but with V-shaped connector portions 17, 19. As shown in the example of FIG. 7, hanger 110 may have a body 15 with connector portions 17, 19 which are in separate planes. Referring to FIG. 8, exemplary hanger 120 may have a single first connector portion 17 and plural second connector portions 19a, 19b thereby enabling hanger 120 to support one or more workpieces. FIG. 9 shows yet another hanger embodiment 130 which utilizes a single hook as connector portion 17 and has plural second connector portions 19a, 19b, 19c.

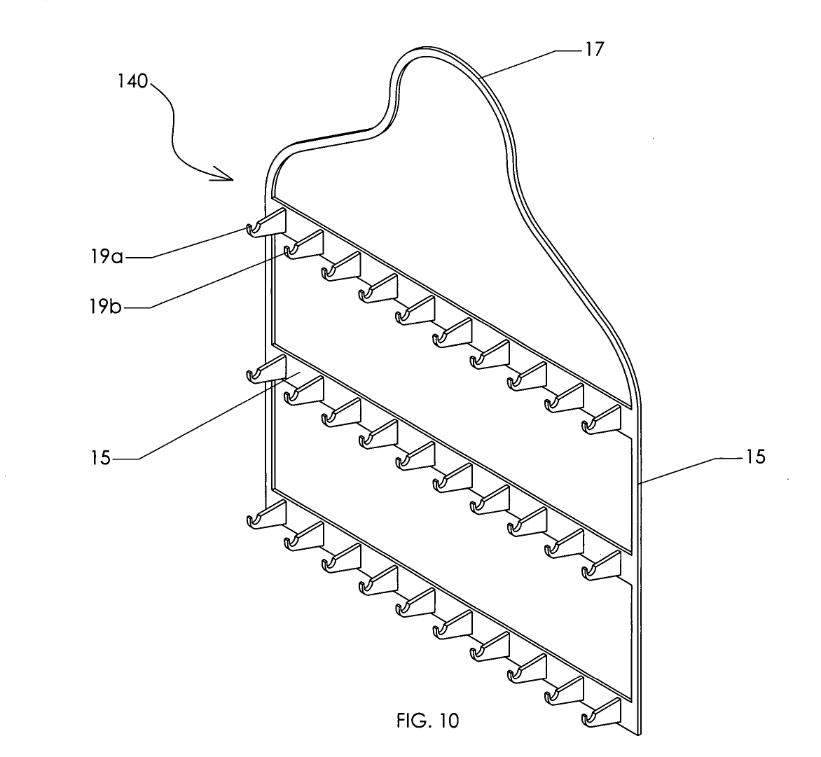

In the embodiment of FIG. 10, hanger 140 is in the form of a rack adapted to potentially support many workpieces 11. Such a hanger has a body 15 which is a unitary one-piece electrically-conductive plastic part. Hanger 140 body 15 includes a first connector portion 17 comprising a bell-shaped hanger and a second connector portion 19 comprising thirty hooks of which hooks 19a and 19b are representative. Hanger 140 could be used in place of a conventional welded-together metal rack.

And, connector portions 17, 19 are not limited to hooks as shown in FIGS. 1-10. While not shown in the figures, connector portions 17, 19 may be provided with a spiral or helical configuration or may be provided with a snap hook mechanism or a locking hook mechanism permitting hangers 10, 100, 110, 120, 130, 140 or workpieces 11 to be more surely held in place.

Methods of electrostatically coating, treating or processing a workpiece using an electrically-conductive plastic hanger can be performed in manually-driven systems or in automated systems. A “system” refers to the collection of devices used in coating, treating and otherwise processing workpiece 11. In a manually-driven system, one or more hanger 10, 100, 110, 120, 130, 140 may be used if it is desired to coat, treat or process one or more workpiece 11. In such a manually-driven system, a human may manually connect a hanger 10, 100, 110, 120, 130, 140 to hook 13 of a rack. Workpiece 11 may be connected to such hanger either before or after the hanger is connected to hook 13. Hook 13 may be in a spray booth, proximate an immersion tank or at another location such that coating material may be applied to workpiece 11. Next, an electrostatic charge is applied to workpiece 11 through hook 13 and hanger 10, 100, 110, 120, 130, 140. Finally, the coating or other material is applied to electrostatically charged workpiece 11.

In an automated coating or processing system (not shown), a plurality of hooks 13 along a conveyor each support a hanger (i.e., hanger 10, 100, 110, 120, 130, 140). Hooks 13 are electrostatically charged and the charge is delivered to workpiece 11 through the hanger from which workpiece 11 is supported. The conveyor then delivers the hangers (i.e., hanger 10, 100, 110, 120, 130, 140) and supported workpieces 11 to a spray booth, immersion tank or other location for application of the coating or other material to the workpiece 11.

After application of the coating or other material to the workpiece 11 in either the manually or automatically driven processes, the workpiece 11 may be cured in a curing oven or otherwise processed to yield the finished workpiece.

Electrically-conductive hangers 10, 100, 110, 120, 130, 140 and other variants provide excellent support for workpieces permitting access to the work piece surfaces by the coating or other material. Such hangers provide the opportunity to ground or otherwise impart an electrical state to work piece 11 as with conventional supports such as metal hangers and racks.

Further, electrically-conductive hangers as described herein solve problems associated with such conventional supports. Electrically-conductive hangers 10, 100, 110, 120, 130, 140 and other variants as described herein solve the coating build up problem because such hangers may be discarded after one coating cycle at a minimal cost to the operator. The hangers may be discarded at minimal cost because they are made of inexpensive, mass-produced plastic materials thereby reducing the cost of each hanger to a fraction of the cost of standard steel wire hooks or welded racks.

As a consequence, energy-intensive cleaning methods such as burn-off cleaning and vibratory cleaning are avoided. Environmental issues are mitigated because generation of ash and off gases is avoided as is the need for chemical stripping agents. Hangers 10, 100, 110, 120, 130, 140 may be safely discarded because such hangers and coatings thereon are essentially inert depending on the particular coating material used. There is even the possibility that a lightly used plastic hook could be recycled at some future date with the proper collection, separation and recycling steps.

By providing a one-piece, unitary hanger 10, 100, 110, 120, 130, 140 any need for an intermediate to join the workpiece 11 to a metal hanger or rack is eliminated as is the need to provide a dip coating over a conventional metal hanger or hook.

Further advantages result from the optional manufacture of hangers 10, 100, 110, 120, 130, 140 and other variants in the form of a joined-together unit, or group, 27 as shown in FIG. 4. Conventional hooks and hangers typically are provided in loose form in a box or other container. Such hooks can become tangled together making it difficult and time consuming to remove individual hangers from the container. By providing the hangers in a connected-together unit, or group, 27 form, the operator simply separates each individual hanger 10 from unit 27 runners 25 on an as-needed basis.

Hangers 10, 100, 110, 120, 130, 140 and other variants can be molded or formed in many different shapes thereby freeing the operator from hand bending individual hooks, as is the most common practice at present.

And, because the plastic material used to make each hanger 10 and unit 27 is lightweight as compared to metal hangers, many units 27 can be shipped easily and inexpensively to the customer.

While the principles of this invention have been described in connection with specific embodiments, it should be understood clearly that these descriptions are made only by way of example and are not intended to limit the scope of the invention.

I claim:

1. An electrically-conductive hanger for supporting a workpiece comprising:
a one-piece hanger body, the body being of an electrically-conductive plastic material;
a first connector portion integral with the body configured to hang the body from a support; and
a second connector portion integral with the body configured to hang a workpiece from the body.

2. The hanger of claim 1 wherein the electrically-conductive plastic material comprises:
at least one plastic material; and
at least one conductive material distributed homogeneously therein.

3. The hanger of claim 2 wherein the plastic material is selected from one or more of the group consisting of polyether ether ketones, polyphenylene sulfides, polyethylenes, liquid crystal polymers, and nylon 6-6.

4. The hanger of claim 2 wherein the conductive material is selected from one or more of the group consisting of metallic powders, carbon black, carbon fibers, carbon mats, metallized glass fibers, metallized glass spheres, copper, aluminum and gold.

5. The hanger of claim 2 wherein the hanger is formed by a process selected from the group consisting of injection molding, blow molding and compression molding.

6. The hanger of claim 2 wherein the first connector portion comprises a hook.

7. The hanger of claim 6 wherein the second connector portion comprises a hook.

8. The hanger of claim 7 wherein the second connector portion comprises plural hooks.

9. The hanger of claim 7 wherein the hanger body has a generally C-shaped configuration.

10. The hanger of claim 7 wherein the hanger body is a rack.

11. The hanger of claim 1 wherein the hanger body is capable of withstanding temperatures of up to about 450° F.

12. The hanger of claim 1 wherein the hanger body has a resistance of less than about 1 megaohm.

13. An electrically-conductive hanger for supporting a workpiece comprising: a one-piece body of plastic including electrically-conductive material embedded homogeneously therein, said body further including a first connector portion adapted to hang the body from a support and a second connector portion adapted to hang a workpiece from the body.

14. The hanger of claim 13 wherein the body is of a thermoplastic material.

15. The hanger of claim 14 wherein the thermoplastic material is selected from one or more of the group consisting of polyether ether ketones, polyphenylene sulfides, polyethylenes, liquid crystal polymers, and nylon 6-6.

16. The hanger of claim 13 wherein the electrically-conductive material is selected from one or more of the group consisting of metallic powders, carbon black, carbon fibers, carbon mats, metallized glass fibers, metallized glass spheres, copper, aluminum and gold.

17. The hanger of claim 13 wherein the hanger is formed by a process selected from the group consisting of injection molding, blow molding and compression molding.

18. The hanger of claim 13 wherein each of the first and second connector portions comprises at least one hook.

19. The hanger of claim 13 wherein the body is capable of withstanding temperatures of up to about 450° F.

20. A method for electrostatic coating of a workpiece comprising:
providing an electrically-conductive plastic hanger for supporting a workpiece comprising:
a one-piece body of plastic including electrically-conductive material associated therewith; and
connector portions formed in the body, at least one of the connector portions being adapted to join the body to a support and at least one other connector portion being adapted to join a workpiece to the body;
hanging a workpiece from the hanger;
imparting an electrical state to the workpiece through the hanger; and
applying a coating to the workpiece.

21. A group of electrically-conductive plastic hangers comprising:
a plurality of one-piece hangers each hanger having a body of an electrically-conductive plastic material including an integral first connector portion configured to hang the body from a support and an integral second connector portion configured to hang a workpiece from the body; and
a connector joining the hangers into the group.

22. The hanger group of claim 21 wherein the electrically-conductive plastic material comprises:
at least one plastic material; and
at least one conductive material distributed homogeneously therein.

23. The hanger group of claim 22 wherein the connector is at least one runner.

24. The hanger group of claim 22 wherein the plastic material is a thermoplastic material.

25. The hanger group of claim 24 wherein the thermoplastic material is selected from one or more of the group consisting of polyether ether ketones, polyphenylene sulfides, polyethylenes, liquid crystal polymers, and nylon 6-6.

26. The hanger group of claim 22 wherein the conductive material is selected from one or more of the group consisting of metallic powders, carbon black, carbon fibers, carbon mats, metallized glass fibers, metallized glass spheres, copper, aluminum and gold.
